(19) United States
(12) Patent Application Publication
(10) Pub. No.: US 2025/0232684 A1
(43) Pub. Date: Jul. 17, 2025

(54) SYSTEMS AND METHODS FOR GENERATING COLLISION AVOIDANCE DIRECTIVES

(71) Applicant: HONEYWELL INTERNATIONAL INC., Charlotte, NC (US)

(72) Inventors: Hao Chen, Shanghai (CN); Zuowei He, Shanghai (CN)

(73) Assignee: HONEYWELL INTERNATIONAL INC., Charlotte, NC (US)

(21) Appl. No.: 18/413,599

(22) Filed: Jan. 16, 2024

(51) Int. Cl. G08G 5/04; G08G 5/00

(52) U.S. Cl. CPC G08G 5/80; G08G 5/21; G08G 5/26; G08G 5/727

(57) ABSTRACT

Systems and methods are provided for generating collision avoidance directives. A current lateral incursion of an intruder aircraft onto a runway is determined based on a location of the intruder aircraft. An incursion line extending across the runway based on the location of the intruder aircraft is defined. A time to collision when an ego aircraft is expected to cross the incursion line is determined. A predicted lateral incursion of the intruder aircraft onto the runway based on the time to collision, the current lateral incursion, and a velocity of the intruder aircraft is generated. A determination is made whether a lateral margin between the ego aircraft and the intruder aircraft on the runway at the time to collision is greater than a lateral margin tolerance. A first directive alert to proceed with the one of a take-off and a landing via the runway is generated based on the determination.

### TECHNICAL FIELD

The present invention generally relates to aircraft operations and more particularly relates to systems and methods for generating collision avoidance directives in an aircraft.

### BACKGROUND

A pilot is typically instructed by air traffic control (ATC) to use a specific runway for aircraft take-off and aircraft landing at an airport. There may be aircraft traffic taxiing across the runway that the pilot has been instructed to use for aircraft take-off or aircraft landing. Pilots often rely on instinct to make judgement calls regarding whether the aircraft traffic on the runway may pose a potential collision risk during take-off or landing. When a pilot determines that there is a potential collision risk with aircraft traffic on the runway, the pilot typically relies on instinct and experience to make real time decisions to avoid a potential collision with the aircraft traffic. Errors in pilot judgement may lead to a potential collision with aircraft traffic.

Hence, there is a need for systems and methods for generating collision avoidance directives in an aircraft.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In various embodiments, a collision avoidance directive generation system includes at least one processor and at least one memory communicatively coupled to the at least one processor. The at least one memory includes instructions that upon execution by the at least one processor, cause the at least one processor to: receive a location and a velocity of an intruder aircraft; determine a current lateral incursion of the intruder aircraft onto a runway based on the location of the intruder aircraft; define an incursion line extending across the runway based on the location of the intruder aircraft; determine a time to collision, wherein an ego aircraft is expected to cross the incursion line on the runway at the time to collision; generate a predicted lateral incursion of the intruder aircraft onto the runway based on the time to collision, the current lateral incursion of the intruder aircraft, and the velocity of the intruder aircraft; determine whether a lateral margin between the ego aircraft and the intruder aircraft on the runway at the time to collision is greater than a lateral margin tolerance, the lateral margin being based at least in part on the predicted lateral incursion; and generate a first directive alert to proceed with the one of a take-off and a landing via the runway to be output to an output device of the ego aircraft based on the determination.

In various embodiments, a method of generating a collision avoidance directive includes: receiving a location and a velocity of an intruder aircraft; determining a current lateral incursion of the intruder aircraft onto a runway based on the location of the intruder aircraft; defining an incursion line extending across the runway based on the location of the intruder aircraft; determining a time to collision, wherein an ego aircraft is expected to cross the incursion line on the runway at the time to collision; generating a predicted lateral incursion of the intruder aircraft onto the runway based on the time to collision, the current lateral incursion of the intruder aircraft, and the velocity of the intruder aircraft; determining whether a lateral margin between the ego aircraft and the intruder aircraft on the runway at the time to collision is greater than a lateral margin tolerance, the lateral margin being based at least in part on the predicted lateral incursion; and generating a first directive alert to proceed with the one of a take-off and a landing via the runway to be output to an output device of the ego aircraft based on the determination.

In various embodiments, a non-transitory machine-readable storage medium that stores instructions executable by at least one processor, the instructions configurable to cause the at least one processor to perform operations including: receiving a location and a velocity of an intruder aircraft; determining a current lateral incursion of the intruder aircraft onto a runway based on the location of the intruder aircraft; defining an incursion line extending across the runway based on the location of the intruder aircraft; determining a time to collision, wherein an ego aircraft is expected to cross the incursion line on the runway at the time to collision; generating a predicted lateral incursion of the intruder aircraft onto the runway based on the time to collision, the current lateral incursion of the intruder aircraft, and the velocity of the intruder aircraft; determining whether a lateral margin between the ego aircraft and the intruder aircraft on the runway at the time to collision is greater than a lateral margin tolerance, the lateral margin being based at least in part on the predicted lateral incursion; and generating a first directive alert to proceed with the one of a take-off and a landing via the runway to be output to an output device of the ego aircraft based on the determination.

Furthermore, other desirable features and characteristics of the systems and methods for generating collision avoidance directives in an aircraft become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 is a block diagram representation of a system configured implement generation of collision avoidance directives in accordance with least one embodiment;

FIG. 2 is a block diagram representation of an ego aircraft including a collision avoidance directive generation system in accordance with at least one embodiment;

FIG. 3 is a flowchart representation of a method of generating collision avoidance directives in an ego aircraft during take-off in accordance with at least one embodiment;

FIG. 4 is a diagrammatic representation of an exemplary current lateral incursion of an intruder aircraft on a runway as the intruder aircraft is leaving the runway in accordance with at least one embodiment;

FIG. 5 is a diagrammatic representation of an exemplary current lateral incursion of an intruder aircraft on a runway as the intruder aircraft is entering the runway in accordance with at least one embodiment;

FIG. 6 is a graphical illustration of an exemplary flight path of an ego aircraft that is greater than a height threshold with respect to a height of an intruder aircraft in accordance with at least one embodiment;

FIG. 7 is a flowchart representation of a method of generating collision avoidance directives in an ego aircraft during landing in accordance with at least one embodiment;

FIG. 8 is a diagrammatic representation of an exemplary path of an ego aircraft with respect to an incursion line on the runway during landing in accordance with at least one embodiment; and

FIG. 9 is a diagrammatic representation of an exemplary horizontal flight path and an exemplary vertical flight path of an ego aircraft that enables the ego aircraft to implement an emergency turn in accordance with at least one embodiment.

### DETAILED DESCRIPTION

The following detailed description is merely exemplary in nature. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

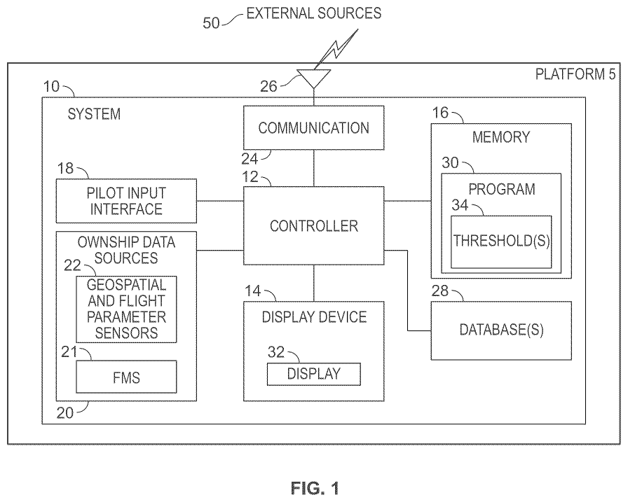

FIG. 1 is a block diagram representation of a system configured implement generation of collision avoidance directives in accordance with least one embodiment (shortened herein to “system” 10), as illustrated in accordance with an exemplary and non-limiting embodiment of the present disclosure. The system 10 may be utilized onboard a mobile platform 5, as described herein. In various embodiments, the mobile platform is an aircraft, which carries or is equipped with the system 10. As schematically depicted in FIG. 1, the system 10 includes the following components or subsystems, each of which may assume the form of a single device or multiple interconnected devices: a controller circuit 12 operationally coupled to: at least one display device 14; computer-readable storage media or memory 16; an optional input interface 18, and ownship data sources 20 including, for example, a flight management system (FMS) 21 and an array of flight system state and geospatial sensors 22.

In various embodiments, the system 10 may be separate from or integrated within: the flight management system (FMS) 21 and/or a flight control system (FCS). Although schematically illustrated in FIG. 1 as a single unit, the individual elements and components of the system 10 can be implemented in a distributed manner utilizing any practical number of physically distinct and operatively interconnected pieces of hardware or equipment. When the system 10 is utilized as described herein, the various components of the system 10 will typically all be located onboard the mobile platform 5.

The term “controller circuit” (and its simplification, “controller”), broadly encompasses those components utilized to carry-out or otherwise support the processing functionalities of the system 10. Accordingly, the controller circuit 12 can encompass or may be associated with a programmable logic array, application specific integrated circuit or other similar firmware, as well as any number of individual processors, flight control computers, navigational equipment pieces, computer-readable memories (including or in addition to the memory 16), power supplies, storage devices, interface cards, and other standardized components. In various embodiments, the controller circuit 12 embodies one or more processors operationally coupled to data storage having stored therein at least one firmware or software program (generally, computer-readable instructions that embody an algorithm) for carrying-out the various process tasks, calculations, and control/display functions described herein. During operation, the controller circuit 12 may be programmed with and execute the at least one firmware or software program, for example, a program 30, that embodies an algorithm described herein for generation of collision avoidance directives in accordance with least one embodiment on a mobile platform 5, where the mobile platform 5 is an aircraft, and to accordingly perform the various process steps, tasks, calculations, and control/display functions described herein.

The controller circuit 12 may exchange data, including real-time wireless data, with one or more external sources 50 to support operation of the system 10 in embodiments. In this case, bidirectional wireless data exchange may occur over a communications network, such as a public or private network implemented in accordance with Transmission Control Protocol/Internet Protocol architectures or other conventional protocol standards. Encryption and mutual authentication techniques may be applied, as appropriate, to ensure data security.

The memory 16 is a data storage that can encompass any number and type of storage media suitable for storing computer-readable code or instructions, such as the aforementioned software program 30, as well as other data generally supporting the operation of the system 10. The memory 16 may also store one or more threshold 34 values, for use by an algorithm embodied in software program 30. One or more database(s) 28 are another form of storage media; they may be integrated with memory 16 or separate from it.

In various embodiments, aircraft-specific parameters and information for an aircraft may be stored in the memory 16 or in a database 28 and referenced by the program 30. Non-limiting examples of aircraft-specific information includes an aircraft weight and dimensions, performance capabilities, configuration options, and the like.

Flight parameter sensors and geospatial sensors 22 supply various types of data or measurements to the controller circuit 12 during an aircraft flight. In various embodiments, the geospatial sensors 22 supply, without limitation, one or more of: inertial reference system measurements providing a location, Flight Path Angle (FPA) measurements, airspeed data, groundspeed data (including groundspeed direction), vertical speed data, vertical acceleration data, altitude data, attitude data including pitch data and roll measurements, yaw data, heading information, sensed atmospheric conditions data (including wind speed and direction data), flight path data, flight track data, radar altitude data, and geometric altitude data.

With continued reference to FIG. 1, the display device 14 can include any number and type of image generating devices on which one or more avionic displays 32 may be produced. When the system 10 is utilized for a manned aircraft, the display device 14 may be affixed to the static structure of the Aircraft cockpit as, for example, a Head Down Display (HDD) or Head Up Display (HUD) unit. In various embodiments, the display device 14 may assume the form of a movable display device (e.g., a pilot-worn display device) or a portable display device, such as an Electronic Flight Bag (EFB), a laptop, or a tablet computer carried into the aircraft cockpit by a pilot.

At least one avionic display 32 is generated on the display device 14 during operation of the system 10; the term “avionic display” is synonymous with the term “aircraft-related display” and “cockpit display” and encompasses displays generated in textual, graphical, cartographical, and other formats. The system 10 can generate various types of lateral and vertical avionic displays 32 on which map views and symbology, text annunciations, and other graphics pertaining to flight planning are presented for a pilot to view. The display device 14 is configured to continuously render at least a lateral display showing the aircraft at its current location within the map data. The avionic display 32 generated and controlled by the system 10 can include graphical user interface (GUI) objects and alphanumerical input displays of the type commonly presented on the screens of multifunction control display units (MCDUs), as well as Control Display Units (CDUs) generally. Specifically, embodiments of the avionic displays 32 include one or more two-dimensional (2D) avionic displays, such as a horizontal (i.e., lateral) navigation display or vertical navigation display (i.e., vertical situation display VSD); and/or on one or more three dimensional (3D) avionic displays, such as a Primary Flight Display (PFD) or an exocentric 3D avionic display.

In various embodiments, a human-machine interface is implemented as an integration of a pilot input interface 18 and a display device 14. In various embodiments, the display device 14 is a touch screen display. In various embodiments, the human-machine interface also includes a separate pilot input interface 18 (such as a keyboard, cursor control device, voice input device, or the like), generally operationally coupled to the display device 14. Via various display and graphics systems processes, the controller circuit 12 may command and control a touch screen display device 14 to generate a variety of graphical user interface (GUI) objects or elements described herein, including, for example, buttons, sliders, and the like, which are used to prompt a user to interact with the human-machine interface to provide user input; and for the controller circuit 12 to activate respective functions and provide user feedback, responsive to received user input at the GUI element.

In various embodiments, the system 10 may also include a dedicated communications circuit 24 configured to provide a real-time bidirectional wired and/or wireless data exchange for the controller 12 to communicate with the external sources 50 (including, each of: traffic, air traffic control (ATC), satellite weather sources, ground stations, and the like). In various embodiments, the communications circuit 24 may include a public or private network implemented in accordance with Transmission Control Protocol/Internet Protocol architectures and/or other conventional protocol standards. Encryption and mutual authentication techniques may be applied, as appropriate, to ensure data security. In some embodiments, the communications circuit 24 is integrated within the controller circuit 12, and in other embodiments, the communications circuit 24 is external to the controller circuit 12. When the external source 50 is “traffic,” the communications circuit 24 may incorporate software and/or hardware for communication protocols as needed for traffic collision avoidance (TCAS), automatic dependent surveillance-broadcast (ADS-B), and enhanced vision systems (EVS).

In certain embodiments of the system 10, the controller circuit 12 and the other components of the system 10 may be integrated within or cooperate with any number and type of systems commonly deployed onboard an aircraft including, for example, an FMS 21.

The disclosed algorithm is embodied in a hardware program or software program (e.g. program 30 in controller circuit 12) and configured to operate when the aircraft is in any phase of flight.

In various embodiments, the provided controller circuit 12, and therefore its program 30 may incorporate the programming instructions for: receiving a location and a velocity of an intruder aircraft; determining a current lateral incursion of the intruder aircraft onto a runway based on the location of the intruder aircraft; defining an incursion line extending across the runway based on the location of the intruder aircraft; determining a time to collision, wherein an ego aircraft is expected to cross the incursion line on the runway at the time to collision; generating a predicted lateral incursion of the intruder aircraft onto the runway based on the time to collision, the current lateral incursion of the intruder aircraft, and the velocity of the intruder aircraft; determining whether a lateral margin between the ego aircraft and the intruder aircraft on the runway at the time to collision is greater than a lateral margin tolerance, the lateral margin being based at least in part on the predicted lateral incursion; and generating a first directive alert to proceed with the one of a take-off and a landing via the runway for display on a display device of the ego aircraft based on the determination.

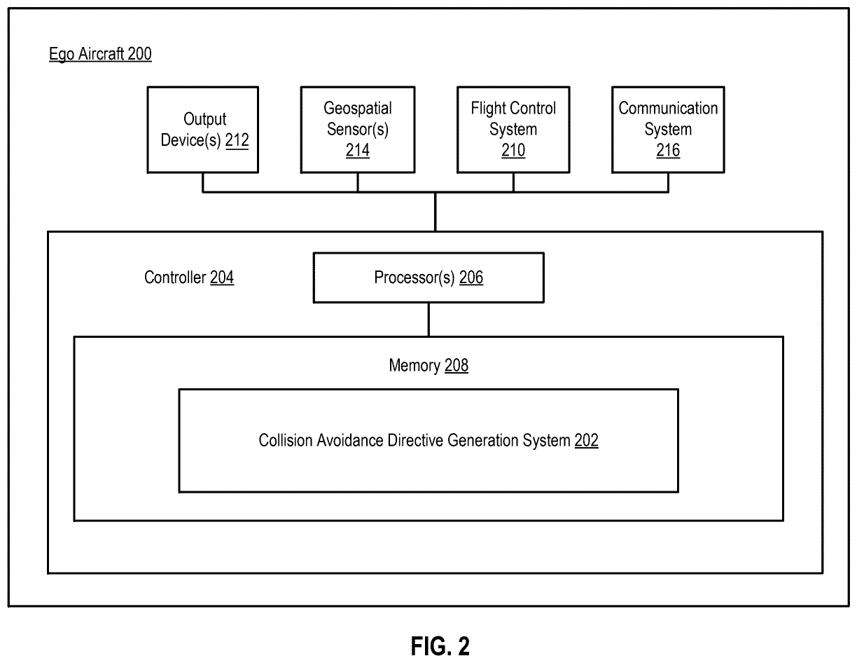

Referring to FIG. 2, a block diagram representation of an ego aircraft 200 including a collision avoidance directive generation system 202 in accordance with at least one embodiment is shown. The ego aircraft 200 may also be referred to as an ownship aircraft. In various embodiments, the configuration of the ego aircraft 200 is similar to the configuration of platform 5 described with reference to FIG. 1. The ego aircraft 200 includes a controller 204. The controller 204 includes at least one processor 206 and at least one memory 208. The at least one memory 308 includes the collision avoidance directive generation system 202. In various embodiments, the controller 204 may include additional components that facilitate operation of the controller 204.

The controller 204 is configured to be communicatively coupled to an FMS 210, one or more output devices 212, one or more geospatial sensors 214, and a communication system 216. The FMS 210 is similar to the FMS 21 in FIG. 1. The one or more geospatial sensors 214 are similar to the geospatial sensors 22 in FIG. 1. The one or more output devices 212 include a display device and speaker. The communication system 216 is similar to the communications circuit 24 in FIG. 1. The operation of the collision avoidance directive generation system 202 will be described in further detail below.

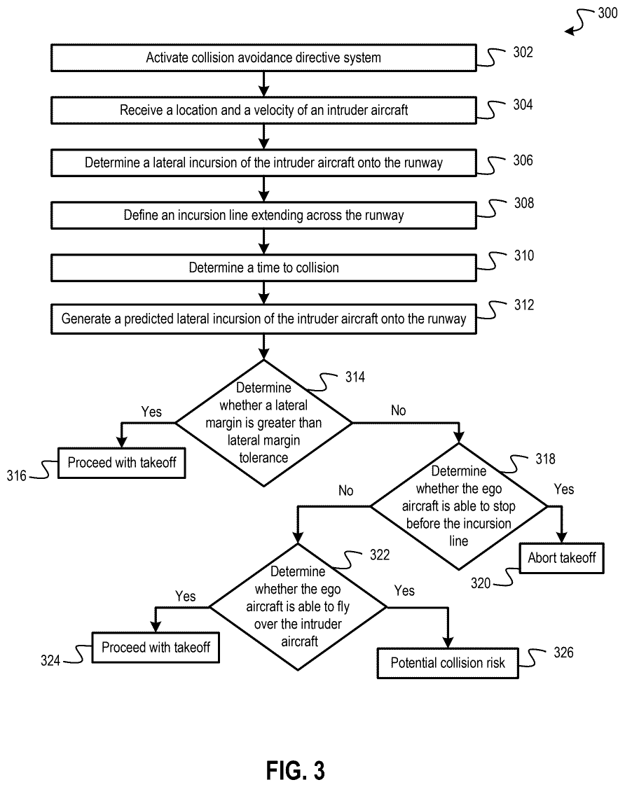

Referring to FIG. 3, a flowchart representation of a method of generating collision avoidance directives in an ego aircraft during take-off in accordance with at least one embodiment is shown. The method 300 will be described with reference to an exemplary implementation of a collision avoidance directive generation system 202. As can be appreciated in light of the disclosure, the order of operation within the method 300 is not limited to the sequential execution as illustrated in FIG. 3 but may be performed in one or more varying orders as applicable and in accordance with the present disclosure.

At 302, the collision avoidance directive generation system 202 is activated. In various embodiments, the collision avoidance directive generation system 202 is activated via pilot input received via a pilot input interface 18. In various embodiments, the collision avoidance directive generation system 202 is automatically activated during take-off.

At 304, the collision avoidance directive generation system 202 receives a location and a velocity of an intruder aircraft. In various embodiments, the collision avoidance directive generation system 202 receives the location and the velocity of the intruder aircraft from an automatic dependent surveillance broadcast (ADS-B) system via the communication system 216 of the ego aircraft 200.

Air traffic control (ATC) typically provides a pilot of the ego aircraft 200 with a runway that has been assigned for use during take-off. At 306, the collision avoidance directive generation system 202 determines a current lateral incursion of the intruder aircraft onto the runway based on the location of the intruder aircraft. At 308, the collision avoidance directive generation system 202 defines an incursion line extending across the runway based on the location of the intruder aircraft.

At 310, the collision avoidance directive generation system 202 determines a time to collision. The ego aircraft 200 is expected to cross the incursion line on the runway at the time to collision. The collision avoidance directive generation system 202 receives a current location and a velocity of the ego aircraft 200 from the geospatial sensor(s) 214. The time to collision is based on the velocity of the ego aircraft 200 and the distance between the current location of the ego aircraft 200 and the incursion line.

At 310, the collision avoidance directive generation system 202 generates a predicted lateral incursion of the ego aircraft 200 onto the runway. The collision avoidance directive generation system 202 generates the predicted lateral incursion of the intruder aircraft onto the runway based on the time to collision, the current lateral incursion of the intruder aircraft onto the runway, and the velocity of the intruder aircraft.

At 312, the collision avoidance directive generation system 202 determines whether a lateral margin is greater than a lateral margin tolerance. The lateral margin is a distance between the ego aircraft 200 and the intruder aircraft on the runway at the time to collision and is based on the predicted lateral incursion of the intruder aircraft onto the runway. The lateral margin tolerance is the minimum safe lateral margin between the ego aircraft 200 and the intruder aircraft that ensures that there is no risk of collision between the ego aircraft 200 and the intruder aircraft at the time to collision at the incursion line.

If the collision avoidance directive generation system 202 determines that the lateral margin is greater than the lateral margin tolerance, the collision avoidance directive generation system 202 generates a directive alert to proceed with take-off via the runway to be output to the output device 212 of the ego aircraft 200 at 314. In various embodiments, the collision avoidance directive generation system 202 generates a traffic on runway alert be output to the output device 212 to alert the pilot of the presence of the intruder aircraft on the runway. The output device 212 may be a display device and/or a speaker. If the collision avoidance directive generation system 202 determines that the lateral margin is less than the lateral margin tolerance, the method 300 proceeds to 316.

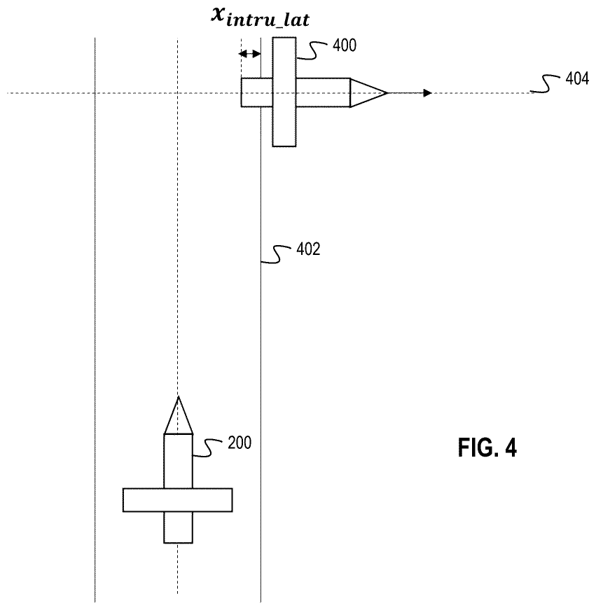

Referring to FIG. 4, a diagrammatic representation of an exemplary current lateral incursion of an intruder aircraft 400 on a runway 402 as the intruder aircraft 400 is leaving the runway 402 in accordance with at least one embodiment is shown. The collision avoidance directive generation system 202 of the ego aircraft 200 receives the location and the velocity v of the intruder aircraft 400 from an ADS-B system via the communication system 216 of the ego aircraft 200.

The collision avoidance directive generation system 202 determines the current lateral incursion x_{intru_lat} of the intruder aircraft 400 onto the runway 402 based on the location of the intruder aircraft 400. The collision avoidance directive generation system 202 defines the incursion line 404 extending across the runway 402 based on the location of the intruder aircraft 400.

The collision avoidance directive generation system 202 receives the current location and the velocity of the ego aircraft 200 from the geospatial sensor(s) 214. The collision avoidance directive generation system 202 determines the time to collision t_{collision}. The ego aircraft 200 is expected to cross the incursion line 404 on the runway at the time to collision t_{collision}. The time to collision t_{collision} is based on the velocity of the ego aircraft 200 and the distance between the current location of the ego aircraft 200 and the incursion line 404.

The collision avoidance directive generation system 202 generates the predicted lateral incursion x_{intru_lat_pred} of the intruder aircraft 400 onto the runway 402 based on the time to collision t_{collision}, the current lateral incursion x_{intru_lat} of the intruder aircraft 400 onto the runway 402, and the velocity v of the intruder aircraft using the relationship defined in the equation below.

x_{intru_lat_pred}=x_{intru_lat}−(t_{collision})(v)

The collision avoidance directive generation system 202 determines whether the lateral margin between the ego aircraft 200 and the intruder aircraft 400 on the runway 402 at the time to collision t_{collision} at the incursion line 404 is greater than the lateral margin tolerance.

If the predicted lateral incursion x_{intru_lat_pred} of the intruder aircraft 400 onto the runway 402 at the time to collision t_{collision} is less than zero, the collision avoidance directive generation system 202 determines that the lateral margin is greater than the lateral margin tolerance and the collision avoidance directive generation system 202 generates a directive alert to proceed with take-off via the runway 402 be output to the output device 212 of the ego aircraft 200. When the predicted lateral incursion x_{intru_lat_pred} of the intruder aircraft 400 onto the runway 402 is less than zero, there intruder aircraft 400 has crossed the runway 402 and there is no risk of a potential collision between the ego aircraft 200 and the intruder aircraft 400.

If the predicted lateral incursion x_{intru_lat_pred} of the intruder aircraft 400 onto the runway 402 at the time to collision t_{collision} is greater than zero, the collision avoidance directive generation system 202 determines whether the lateral margin between the ego aircraft 200 and the intruder aircraft 400 on the runway 402 at the time to collision t_{collision} is greater than the lateral margin tolerance x_{delta}. The collision avoidance directive generation system 202 determines whether a sum of predicted lateral incursion x_{intru_lat_pred} of the intruder aircraft 400 onto the runway 402, half the wingspan x_{half_wing_span} of the ego aircraft 200, and the lateral margin tolerance x_{delta} is less than half a width x_{half_runway_width} of the runway 402. This relationship is defined by the equation below.

x_{half_wing_span}+x_{intru_lat_pred}+x_{delta}<x_{half_runway_width}

If the collision avoidance directive generation system 202 determines that the sum of predicted lateral incursion x_{intru_lat_pred} of the intruder aircraft 400 onto the runway 402, half the wingspan x_{half_wing_span} of the ego aircraft 200, and the lateral margin tolerance x_{delta} is less than half a width x_{half_runway_width} of the runway 402, the collision avoidance directive generation system 202 generates a directive alert to proceed with take-off via the runway 402 be output to the output device 212 of the ego aircraft 200.

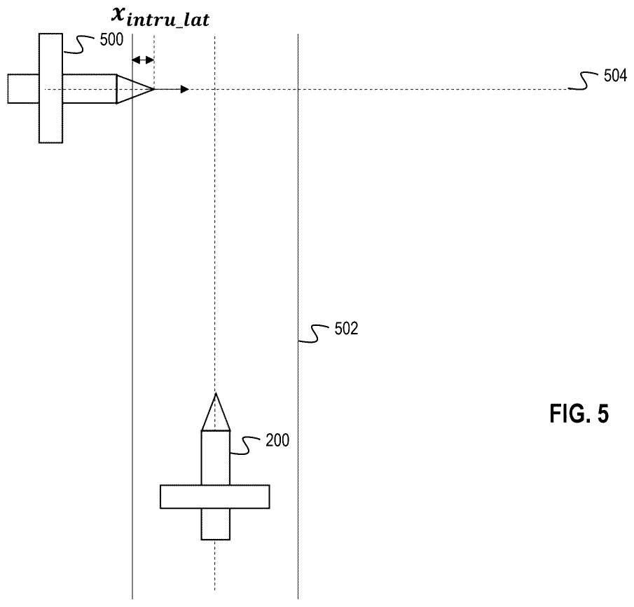

Referring to FIG. 5, a diagrammatic representation of an exemplary current lateral incursion of an intruder aircraft 500 on a runway 502 as the intruder aircraft 500 is entering the runway 502 in accordance with at least one embodiment is shown. The collision avoidance directive generation system 202 of the ego aircraft 200 receives the location and the velocity v of the intruder aircraft 500 from an ADS-B system via the communication system 216 of the ego aircraft 200.

The collision avoidance directive generation system 202 determines the current lateral incursion x_{intru_lat} of the intruder aircraft 500 onto the runway 502 based on the location of the intruder aircraft 500. The collision avoidance directive generation system 202 defines the incursion line 504 extending across the runway 502 based on the location of the intruder aircraft 500.

The collision avoidance directive generation system 202 receives the current location and the velocity of the ego aircraft 200 from the geospatial sensor(s) 214. The collision avoidance directive generation system 202 determines the time to collision t_{collision}. The ego aircraft 200 is expected to cross the incursion line 504 on the runway 502 at the time to collision t_{collision}. The time to collision t_{collision} is based on the velocity of the ego aircraft 200 and the distance between the current location of the ego aircraft 200 and the incursion line 504.

The collision avoidance directive generation system 202 generates the predicted lateral incursion x_{intru_lat_pred} of the intruder aircraft 500 onto the runway 502 based on the time to collision t_{collision}, the current lateral incursion x_{intru_lat} of the intruder aircraft 500 onto the runway 502, and the velocity v of the intruder aircraft using the relationship defined in the equation below.

x_{intru_lat_pred}=x_{intru_lat}+(t_{collision})(v)

The collision avoidance directive generation system 202 determines whether the lateral margin between the ego aircraft 200 and the intruder aircraft 500 on the runway 502 at the time to collision t_{collision} at the incursion line 504 is greater than the lateral margin tolerance x_{delta}. The collision avoidance directive generation system 202 determines whether a sum of predicted lateral incursion x_{intru_lat_pred} of the intruder aircraft 500 onto the runway 502, half the wingspan x_{half_wing_span} of the ego aircraft 200, and the lateral margin tolerance x_{delta} is less than half a width x_{half_runway_width} of the runway 502. This relationship is represented by the equation below.

x_{half_wing_span}+x_{intru_lat_pred}+x_{delta}<x_{half_runway_width}

If the collision avoidance directive generation system 202 determines that the sum of predicted lateral incursion x_{intru_lat_pred} of the intruder aircraft 500 onto the runway 502, half the wingspan x_{half_wing_span} of the ego aircraft 200, and the lateral margin tolerance x_{delta} is less than half the width x_{half_runway_width} of the runway 502, the collision avoidance directive generation system 202 generates a directive alert to proceed with take-off via the runway 502 be output to the output device 212 of the ego aircraft 200.

Referring back to FIG. 2, if the collision avoidance directive generation system 202 determines that the lateral margin is less than the lateral margin tolerance at 314, the collision avoidance directive generation system 202 determines whether the ego aircraft 200 is able to stop prior to arrival at the incursion line at 318. If the lateral margin is less than the lateral margin tolerance, there is an increased risk of a collision between the ego aircraft 200 and the intruder aircraft if the ego aircraft 200 attempts to take-off. The collision avoidance directive generation system 202 determines whether the ego aircraft 200 is able to stop prior to reaching the incursion line to avoid a collision with the intruder aircraft.

The collision avoidance directive generation system 202 determines whether a maximum ego aircraft stopping distance is less than a distance between the current location of the ego aircraft 200 and the incursion line. The maximum ego aircraft stopping distance is calculated using the equation below:

maximum ego aircraft stopping distance=v*tᵣₑₛₚₒₙₛₑ+d

where v is the velocity of the ego aircraft, tᵣₑₛₚₒₙₛₑ is pilot response time, and d is the braking distance of the ego aircraft 200 when a maximum braking force is applied to the ego aircraft 200.

If the collision avoidance directive generation system 202 determines at that the maximum ego aircraft stopping distance is less than the distance between the current location of the ego aircraft 200 and the incursion line, the collision avoidance directive generation system 202 generates a directive alert to abort take-off be output to the output device 212 of the ego aircraft 200 at 320. In various embodiments, the collision avoidance directive generation system 202 generates a stop aircraft alert be output to the output device 212 to alert the pilot stop the ego aircraft 200. In various embodiments, the collision avoidance directive generation system 202 generates a traffic on runway alert be output to the output device 212 to alert the pilot of the presence of the intruder aircraft on the runway.

If the collision avoidance directive generation system 202 determines that the ego aircraft 200 is unable to stop prior to reaching the incursion line to avoid a collision with the intruder aircraft at 318, the collision avoidance directive generation system 202 determines whether the ego aircraft 200 is able to fly over the intruder aircraft at 322. The collision avoidance directive generation system 202 determines whether an altitude of the ego aircraft 200 on a flight path of the ego aircraft 200 during take-off at the incursion line is greater than a height threshold with respect to a height of the intruder aircraft.

If the collision avoidance directive generation system 202 determines that the altitude of the ego aircraft 200 on the flight path of the ego aircraft 200 during take-off at the incursion line is greater than the height threshold with respect to the height of the intruder aircraft, the collision avoidance directive generation system 202 generates a directive alert to proceed with take-off via the runway be output to the output device 212 of the ego aircraft 200 at 324. In various embodiments, the collision avoidance directive generation system 202 generates a traffic on runway alert be output to the output device 212 to alert the pilot of the presence of the intruder aircraft on the runway.

If the collision avoidance directive generation system 202 determines that the ego aircraft 200 is unable to take-off and fly over the intruder aircraft at 322, the collision avoidance directive generation system 202 generates a directive alert of a potential collision risk with the intruder aircraft be output to the output device 212 of the ego aircraft 200 at 326. The pilot is alerted to implement action to avoid a collision with the intruder aircraft. For example, the pilot may guide the ego aircraft 200 off the runway to avoid a collision with the intruder aircraft.

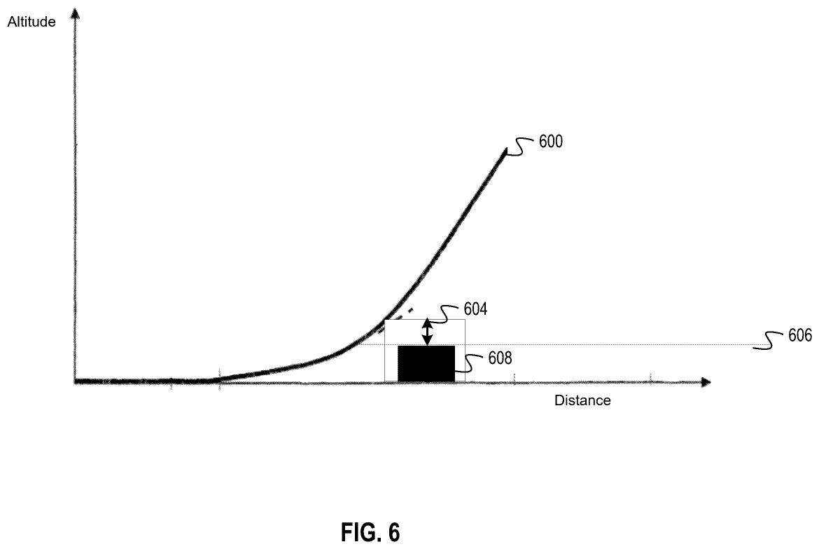

Referring to FIG. 6, a graphical illustration of an exemplary flight path 600 of an ego aircraft 200 that is greater than a height threshold 604 with respect to a height 606 of an intruder aircraft 608 in accordance with at least one embodiment is shown. The altitude of the ego aircraft 200 along the flight path 600 of the ego aircraft 200 is represented as a function of distance on the runway. The intruder aircraft 608 is located at the incursion line of the runway. The difference between the altitude of the ego aircraft 200 and the height 606 of the intruder aircraft 608 is greater than the height threshold 604 at the incursion line. The collision avoidance directive generation system 202 determines that the ego aircraft 200 is able to take-off and fly over the intruder aircraft at 608 and generates a directive alert to proceed with take-off via the runway be output to the output device 212 of the ego aircraft 200. In various embodiments, the collision avoidance directive generation system 202 generates a traffic on runway alert be output to the output device 212 to alert the pilot of the presence of the intruder aircraft 608 on the runway.

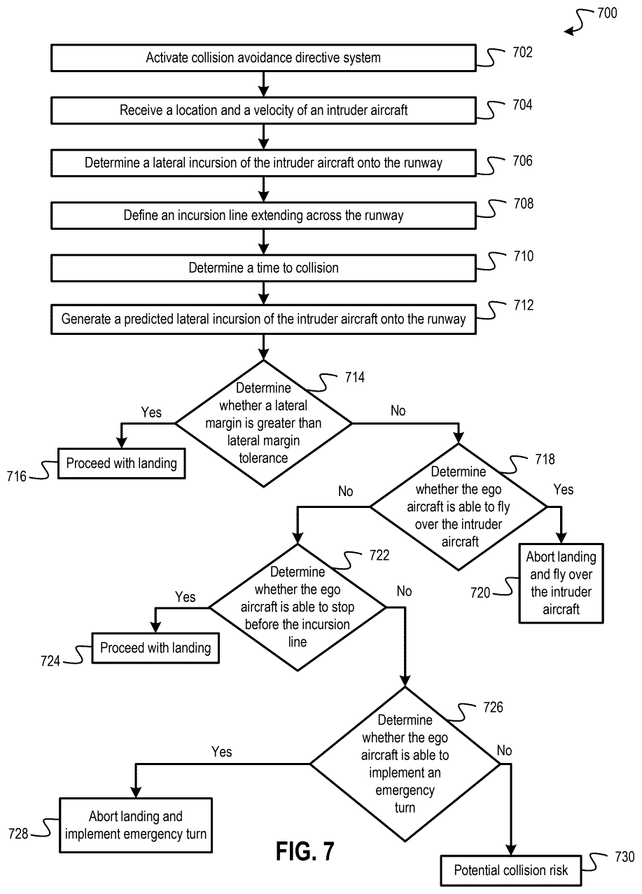

Referring to FIG. 7, a flowchart representation of a method 700 of generating collision avoidance directives in an ego aircraft 200 during landing in accordance with at least one embodiment is shown. The method 700 will be described with reference to an exemplary implementation of a collision avoidance directive generation system 202. As can be appreciated in light of the disclosure, the order of operation within the method 700 is not limited to the sequential execution as illustrated in FIG. 7 but may be performed in one or more varying orders as applicable and in accordance with the present disclosure.

At 702, the collision avoidance directive generation system 202 is activated. In various embodiments, the collision avoidance directive generation system 202 is activated via pilot input received via a pilot input interface 18. In various embodiments, the collision avoidance directive generation system 202 is automatically activated during landing.

At 704, the collision avoidance directive generation system 202 receives a location and a velocity of an intruder aircraft. In various embodiments, the collision avoidance directive generation system 202 receives the location and the velocity of the intruder aircraft from an automatic dependent surveillance broadcast (ADS-B) system via the communication system 216 of the ego aircraft.

Air traffic control (ATC) typically provides a pilot of the ego aircraft with the runway that has been assigned for use during landing. At 706, the collision avoidance directive generation system 202 determines a current lateral incursion of the intruder aircraft onto the runway based on the location of the intruder aircraft. At 708, the collision avoidance directive generation system 202 defines an incursion line extending across the runway based on the location of the intruder aircraft.

At 710, the collision avoidance directive generation system 202 determines a time to collision. The ego aircraft 200 is expected to cross the incursion line on the runway at the time to collision. The time to collision is based on an expected deceleration of the ego aircraft 200 following touchdown and the distance between the touchdown location on the runway and the incursion line. The pilot of the ego aircraft 200 initiates the application of brakes to the ego aircraft 200 at a braking initiation location on the runway following a pilot response time after touchdown at the touchdown location. In various embodiments, the time to collision is based on an expected deceleration of the ego aircraft 200 and the distance between the braking initiation location on the runway and the incursion line.

At 712, the collision avoidance directive generation system 202 generates a predicted lateral incursion of the intruder aircraft onto the runway. The collision avoidance directive generation system 202 generates the predicted lateral incursion of the intruder aircraft onto the runway based on the time to collision, the current lateral incursion of the intruder aircraft onto the runway, and the velocity of the intruder aircraft. The collision avoidance directive generation system 202 generates the predicted lateral incursion as described with reference to the generation of the predicted lateral incursion of the intruder aircraft during take-off of the ego aircraft 200 above.

At 714, the collision avoidance directive generation system 202 determines whether a lateral margin is greater than a lateral margin tolerance. The lateral margin is a distance between the ego aircraft 200 and the intruder aircraft on the runway at the time to collision at the incursion line and is based on the predicted lateral incursion of the intruder aircraft onto the runway. The lateral margin tolerance is the minimum safe lateral margin between the ego aircraft 200 and the intruder aircraft at the incursion line that ensures that there is no risk of collision between the ego aircraft 200 and the intruder aircraft at the time to collision at the incursion line. The collision avoidance directive generation system 202 determines whether a lateral margin is greater than a lateral margin tolerance as described with reference to the determination of whether the lateral margin is greater than the lateral margin tolerance above during take-off.

If the collision avoidance directive generation system 202 determines that the lateral margin is greater than the lateral margin tolerance at 714, the collision avoidance directive generation system 202 generates a directive alert to proceed with landing on the runway be output to the output device 212 of the ego aircraft 200 at 716. In various embodiments, the collision avoidance directive generation system 202 generates a traffic on runway alert be output to the output device 212 to alert the pilot of the presence of the intruder aircraft on the runway.

If the collision avoidance directive generation system 202 determines that the lateral margin is less than the lateral margin tolerance at 714, the collision avoidance directive generation system 202 determines whether the ego aircraft 200 is able to abort landing and fly over the intruder aircraft at 718. The collision avoidance directive generation system 202 determines whether an altitude of the ego aircraft 200 on a flight path of the ego aircraft 200 at the incursion line is greater than a height threshold with respect to the height of the intruder aircraft. The intruder aircraft is located at the incursion line of the runway. The collision avoidance directive generation system 202 determines whether a difference between the altitude of the ego aircraft 200 and the height of the intruder aircraft is greater than the height threshold at the incursion line.

If the collision avoidance directive generation system 202 determines that the ego aircraft 200 is able to fly over the intruder aircraft during an aborted landing at 718, the collision avoidance directive generation system 202 generates a directive alert to abort landing and fly over the intruder aircraft be output to the output device 212 of the ego aircraft 200 at 720. In various embodiments, the collision avoidance directive generation system 202 generates a traffic on runway alert be output to the output device 212 to alert the pilot of the presence of the intruder aircraft on the runway.

If the collision avoidance directive generation system 202 determines that the ego aircraft 200 is unable to fly over the intruder aircraft during an aborted landing at 718, the collision avoidance directive generation system 202 determines whether upon landing, the ego aircraft 200 is able to stop prior to arrival at the incursion line to avoid a collision with the intruder aircraft at 722. The collision avoidance directive generation system 202 determines whether a sum of the ego aircraft response time distance and a maximum ego aircraft stopping distance is less than a distance between a touchdown location on the runway and the incursion line. The ego aircraft 200 touches down at a touchdown location on the runway during landing. The ego aircraft response time distance is the distance that the ego aircraft 200 travels during a pilot response time prior to the initiation of an application of a maximum braking force to bring the ego aircraft 200 to a stop. The maximum ego aircraft stopping distance is the braking distance of the ego aircraft 200 when a maximum braking force is applied to the ego aircraft 200.

If the collision avoidance directive generation system 202 determines that the ego aircraft 200 is able to stop prior to arrival at the incursion line to avoid a collision with the intruder aircraft at 722, the collision avoidance directive generation system 202 generates a directive alert to proceed with landing be output to the output device 212 of the ego aircraft 200 at 724. In various embodiments, the collision avoidance directive generation system 202 generates a stop aircraft alert be output to the output device 212 to alert the pilot stop the ego aircraft 200. In various embodiments, the collision avoidance directive generation system 202 generates a traffic on runway alert be output to the output device 212 to alert the pilot of the presence of the intruder aircraft on the runway. If the collision avoidance directive generation system 202 determines that the ego aircraft 200 is unable to stop prior to arrival at the incursion line to avoid a collision with the intruder aircraft at 722, the method 700 proceed to 726.

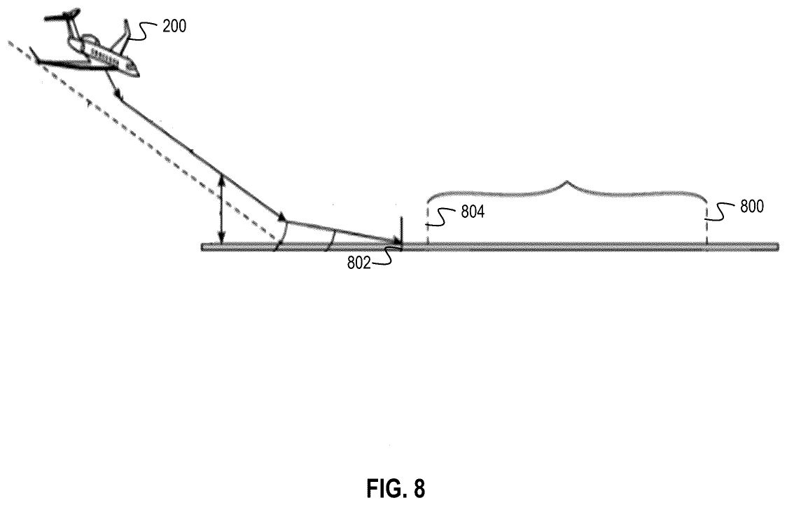

Referring to FIG. 8, a diagrammatic representation of an exemplary path of an ego aircraft 200 with respect to an incursion line 800 on the runway during landing in accordance with at least one embodiment is shown. The ego aircraft 200 touches down at a touchdown location 802 on the runway during landing. Braking of the ego aircraft 200 is initiated at a braking initiation location 804 on the runway. The incursion line 800 is based on the location of the intruder aircraft. The ego aircraft response time distance extends between the touchdown location 802 and the braking initiation location 804. In order for the ego aircraft 200 to avoid a collision with the intruder aircraft, the maximum ego aircraft braking distance has to be less than the distance between the braking initiation location 804 and the incursion line 800. The sum of the ego aircraft response time and the maximum ego aircraft braking distance has to be less than the distance between the touchdown location 802 on the runway and the incursion line 800 in order to avoid a collision with the intruder aircraft.

If the collision avoidance directive generation system 202 determines that the ego aircraft 200 is unable to stop prior to arrival at the incursion line to avoid a collision with the intruder aircraft at 722, the collision avoidance directive generation system 202 determines whether the ego aircraft 200 is able to abort landing an implement an emergency turn at 726. The collision avoidance directive generation system 202 determines whether a safety margin between the ego aircraft 200 and the intruder aircraft on a horizontal plane of a flight path of the ego aircraft 200 enables the ego aircraft 200 to implement an emergency turn to avoid a collision with the intruder aircraft.

If the collision avoidance directive generation system 202 determines that the ego aircraft 200 is able to abort landing and implement an emergency turn at 726, the collision avoidance directive generation system 202 issues a directive to abort landing and implement an emergency turn at 728. In at least one embodiment, the emergency turn is displayed on a display device of the ego aircraft 200. In various embodiments, the collision avoidance directive generation system 202 generates a traffic on runway alert be output to the output device 212 to alert the pilot of the presence of the intruder aircraft on the runway.

If the collision avoidance directive generation system 202 determines that the ego aircraft 200 is unable to abort landing and implement an emergency turn at 726, the collision avoidance directive generation system 202 generates a directive alert of a potential collision risk with the intruder aircraft be output to the output device 212 of the ego aircraft 200 at 730. The pilot uses personal judgement to implement action to avoid a potential collision with the intruder aircraft.

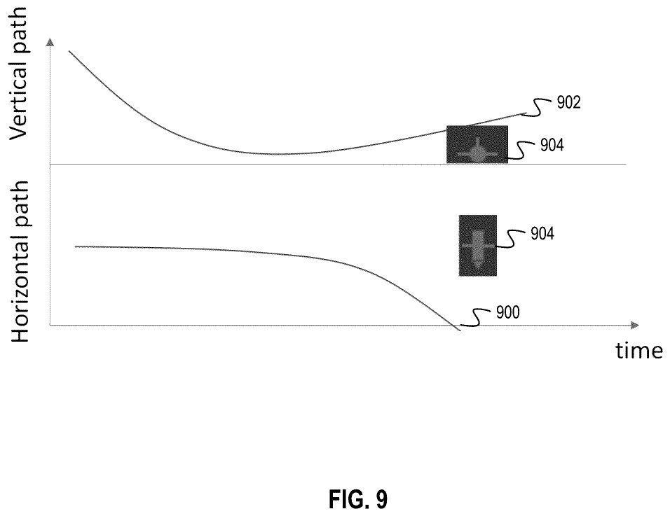

Referring to FIG. 9, a diagrammatic representation of an exemplary horizontal flight path 900 and an exemplary vertical flight path 902 of an ego aircraft 200 that enables the ego aircraft 200 to implement an emergency turn in accordance with at least one embodiment is shown. The vertical light path 900 and the horizontal flight path 902 are represented as a function of time. The vertical flight path 902 illustrates that there is sufficient clearance between a height of the intruder aircraft 904 and the vertical flight path 902 of the ego aircraft 200 at the incursion line to support the implementation of the emergency turn. The horizontal flight path 900 depicts the implementation of the emergency turn. There is a sufficient clearance between the ego aircraft 200 and the intruder aircraft 904 on a horizontal plane of the flight path of the ego aircraft 200 to enable the ego aircraft 200 to implement the emergency turn represented by the horizontal flight path 900. The collision avoidance directive generation system 202 issues a directive to abort landing and implement an emergency turn in accordance with the vertical flight path 902 and the horizontal flight path 900. The collision avoidance directive generation system 202 generates a traffic on runway alert be output to the output device 212 to alert the pilot of the presence of the intruder aircraft on the runway. The minimum clearance needed between the height of the intruder aircraft 904 and the vertical flight path 902 of the ego aircraft 200 at the incursion line to support the implementation of the emergency turn and the minimum clearance needed between the ego aircraft 200 and the intruder aircraft 904 on the horizontal plane of the flight path of the ego aircraft 200 to enable the ego aircraft 200 to implement the emergency turn define the safety margin needed to safely implement the emergency turn.

The directive alert(s) are generated by the collision avoidance directive generation system 202 to be output to an output device 212 of the ego aircraft 200. In various embodiments, the output device 212 is a display device and the collision avoidance directive generation system 202 generates the directive alert(s) to be displayed on the display device of the ego aircraft 200. In various embodiments, the output device 212 is a speaker and the collision avoidance directive generation system 202 generates the directive alert(s) as aural directive alert(s) to be output to the speaker of the ego aircraft 200. In various embodiments, the collision avoidance directive generation system 202 generates the directive alert(s) as aural directive alert(s) to be output to the speaker of the ego aircraft 200 and for display on the display device of the ego aircraft 200.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A collision avoidance directive generation system comprising:
at least one processor; and
at least one memory communicatively coupled to the at least one processor, the at least one memory comprising instructions that upon execution by the at least one processor, cause the at least one processor to:
receive a location and a velocity of an intruder aircraft;
determine a current lateral incursion of the intruder aircraft onto a runway based on the location of the intruder aircraft;
define an incursion line extending across the runway based on the location of the intruder aircraft;
determine a time to collision, wherein an ego aircraft is expected to cross the incursion line on the runway at the time to collision;
generate a predicted lateral incursion of the intruder aircraft onto the runway based on the time to collision, the current lateral incursion of the intruder aircraft, and the velocity of the intruder aircraft;
determine whether a lateral margin between the ego aircraft and the intruder aircraft on the runway at the time to collision is greater than a lateral margin tolerance, the lateral margin being based at least in part on the predicted lateral incursion; and
generate a first directive alert to proceed with the one of a take-off and a landing via the runway to be output to an output device of the ego aircraft based on the determination.

2. The system of claim 1, wherein the location of the intruder aircraft and the current velocity of the intruder aircraft are received from an automatic dependent surveillance broadcast (ADS-B) system.

3. The system of claim 1, wherein, the at least one memory comprises instructions that upon execution by the at least one processor, cause the at least one processor to:
determine whether the predicted lateral incursion of the intruder aircraft onto the runway is less than zero; and
generate the first directive alert to proceed with the one of the take-off and the landing based on the determination.

4. The system of claim 1, wherein, the at least one memory comprises instructions that upon execution by the at least one processor, cause the at least one processor to:
determine whether a sum of the predicted lateral intrusion, half a wing-span of the ego aircraft, and the lateral margin tolerance is less than half a width of the runway; and
generate the first directive alert to proceed with the one of the take-off and the landing based on the determination.

5. The system of claim 1, wherein, the at least one memory comprises instructions that upon execution by the at least one processor, cause the at least one processor to:
determine whether a sum of an ego aircraft response time distance and a maximum ego aircraft stopping distance is less than a distance between a current location of the ego aircraft on the runway and the incursion line; and
generate a second directive alert to stop the ego aircraft on the runway and abort the take-off to be output to the output device of the ego aircraft based on the determination.

6. The system of claim 1, wherein, the at least one memory comprises instructions that upon execution by the at least one processor, cause the at least one processor to:
determine whether an altitude of the ego aircraft along a flight path of the ego aircraft during the take-off is greater than a height threshold with respect to a height of the intruder aircraft at the incursion line; and
generate the first directive alert to proceed with the take-off based on the determination.

7. The system of claim 1, wherein, the at least one memory comprises instructions that upon execution by the at least one processor, cause the at least one processor to:
determine whether an altitude of the ego aircraft along a flight path of the ego aircraft during an aborted landing is greater than a height threshold with respect to a height of the intruder aircraft at the incursion line; and
generate a third directive alert to fly over the intruder aircraft and abort the landing to be output to the output device the ego aircraft based on the determination.

8. The system of claim 1, wherein, the at least one memory comprises instructions that upon execution by the at least one processor, cause the at least one processor to:
determine whether a sum of an ego aircraft response time distance and a maximum ego aircraft stopping distance is less than a distance between a touchdown location on the runway and the incursion line; and
generate the first directive alert to proceed with the landing based on the determination.

9. The system of claim 1, wherein, the at least one memory comprises instructions that upon execution by the at least one processor, cause the at least one processor to:
determine whether a safety margin between the ego aircraft and the intruder aircraft on a horizontal plane of a flight path of the ego aircraft enables the ego aircraft to implement an emergency turn; and
generate a fourth directive alert to implement the emergency turn and abort the landing to be output to the output device of the ego aircraft based on the determination.

10. The system of claim 1, wherein the output device of the ego aircraft is one of a display device and a speaker.

11. A method of generating a collision avoidance directive comprising:
receiving a location and a velocity of an intruder aircraft;
determining a current lateral incursion of the intruder aircraft onto a runway based on the location of the intruder aircraft;
defining an incursion line extending across the runway based on the location of the intruder aircraft;
determining a time to collision, wherein an ego aircraft is expected to cross the incursion line on the runway at the time to collision;
generating a predicted lateral incursion of the intruder aircraft onto the runway based on the time to collision, the current lateral incursion of the intruder aircraft, and the velocity of the intruder aircraft;
determining whether a lateral margin between the ego aircraft and the intruder aircraft on the runway at the time to collision is greater than a lateral margin tolerance, the lateral margin being based at least in part on the predicted lateral incursion; and
generating a first directive alert to proceed with the one of a take-off and a landing via the runway to be output to an output device of the ego aircraft based on the determination.

12. The method of claim 11, further comprising receiving the location of the intruder aircraft and the current velocity of the intruder aircraft from an automatic dependent surveillance broadcast (ADS-B) system.

13. The method of claim 11, further comprising:
determining whether the predicted lateral incursion of the intruder aircraft onto the runway is less than zero; and
generating the first directive alert to proceed with the one of the take-off and the landing based on the determination.

14. The method of claim 11, further comprising:
determining whether a sum of the predicted lateral intrusion, half a wing-span of the ego aircraft, and the lateral margin tolerance is less than half a width of the runway; and
generating the first directive alert to proceed with the one of the take-off and the landing based on the determination.

15. The method of claim 11, further comprising:
determining whether a sum of an ego aircraft response time and a maximum ego aircraft stopping distance is less than a distance between a current location of the ego aircraft on the runway and the incursion line; and
generating a second directive alert to stop the ego aircraft on the runway and abort the take-off to be output to the output device of the ego aircraft based on the determination.

16. The method of claim 11, further comprising:
determining whether a flight path of the ego aircraft during the take-off is greater than a height threshold with respect to the intruder aircraft; and
generating the first directive alert to proceed with the take-off based on the determination.

17. The method of claim 11, further comprising:
determining whether a flight path of the ego aircraft during an aborted landing is greater than a height threshold with respect to the intruder aircraft; and
generating a third directive alert to fly over the intruder aircraft and abort the landing to be output to the output device of the ego aircraft based on the determination.

18. The method of claim 11, further comprising:
determining whether a sum of an ego aircraft response time and a maximum ego aircraft stopping distance is less than a distance between a touchdown location on the runway and the incursion line; and
generating the first directive alert to proceed with the landing based on the determination.

19. The method of claim 11, further comprising:
determining whether a safety margin between the ego aircraft and the intruder aircraft on a horizontal plane of a flight path of the ego aircraft enables the ego aircraft to implement an emergency turn; and
generating a fourth directive alert to implement the emergency turn and abort the landing to be output to the output device of the ego aircraft based on the determination.

20. A non-transitory machine-readable storage medium that stores instructions executable by at least one processor, the instructions configurable to cause the at least one processor to perform operations comprising:
receiving a location and a velocity of an intruder aircraft;
determining a current lateral incursion of the intruder aircraft onto a runway based on the location of the intruder aircraft;
defining an incursion line extending across the runway based on the location of the intruder aircraft;
determining a time to collision, wherein an ego aircraft is expected to cross the incursion line on the runway at the time to collision;
generating a predicted lateral incursion of the intruder aircraft onto the runway based on the time to collision, the current lateral incursion of the intruder aircraft, and the velocity of the intruder aircraft;
determining whether a lateral margin between the ego aircraft and the intruder aircraft on the runway at the time to collision is greater than a lateral margin tolerance, the lateral margin being based at least in part on the predicted lateral incursion; and
generating a first directive alert to proceed with the one of a take-off and a landing via the runway to be output to an output device of the ego aircraft based on the determination.
